(19) United States
(12) Patent Application Publication
(10) Pub. No.: US 2023/0053800 A1
(43) Pub. Date: Feb. 23, 2023

(54) BATTERY MODULE EASY TO ASSEMBLE

(71) Applicant: LUXSHARE-ICT CO., LTD., TAIPEI CITY (TW)

(72) Inventors: Chuntai LEE, TAIPEI CITY (TW); Cheng ZHAO, TAIPEI CITY (TW)

(73) Assignee: LUXSHARE-ICT CO., LTD., TAIPEI CITY (TW)

(21) Appl. No.: 17/741,831

(22) Filed: May 11, 2022

(30) Foreign Application Priority Data
Aug. 20, 2021 (CN) 202121965276.5

(51) Int. Cl. H01M 50/258; H01M 50/507; H01M 50/298; H01M 50/516

(52) U.S. Cl. CPC H01M 50/258; H01M 50/507; H01M 50/298; H01M 50/516; H01M 50/249

(57) ABSTRACT

A battery module includes batteries, bus bars, a flexible flat cable and connecting terminals. Each battery includes a first electrode and a second electrode. Each bus bar connects the first electrode of one battery with the second electrode of another battery. At least one of the bus bar is arranged obliquely. The flexible flat cable includes a number of wires arranged in parallel. Each connecting terminal includes a first connecting portion connected to a corresponding bus bar and a second connecting portion connected to a corresponding wire of the flexible flat cable. Compared with the prior art, at least one of the bus bars of the present disclosure is arranged obliquely, thereby reducing the difficulty of arranging the batteries. In addition, by providing the first connecting portion and the second connecting portion, it is convenient to realize the assembly of the battery module.

### CROSS-REFERENCE TO RELATED APPLICATION

This patent application claims priority of a Chinese Patent Application No. 202121965276.5, filed on Aug. 20, 2021 and titled “BATTERY MODULE”, the entire content of which is incorporated herein by reference.

### TECHNICAL FIELD

The present disclosure relates to a battery module, which belongs to a technical field of batteries.

### BACKGROUND

As the development speed of new energy vehicles is getting faster and faster, the demand for batteries in related industries is also getting higher and higher. A battery module usually includes multiple groups of batteries and multiple bus bars connecting these batteries in series or in parallel. In order to ensure that the batteries can work normally and safely, it is necessary to use a sampling component to monitor the working state of the batteries.

The sampling component includes a sampling circuit and a plurality of connecting terminals for signal transmission, in which the connecting terminals are used for connecting the bus bars and the sampling circuit. In the relevant art, according to the arrangement of the batteries, it is often necessary to design connecting terminals with different lengths in order to connect the bus bars and the sampling circuit, which obviously increases the manufacturing difficulty. Therefore, how to improve the convenience of assembling the battery module is a technical problem that needs to be solved by those skilled in the art.

### SUMMARY

An object of the present disclosure is to provide a battery module which is easy to assemble.

In order to achieve the above object, the present disclosure adopts the following technical solution: a battery module, including: a plurality of batteries, each battery including a first electrode and a second electrode, one of the first electrode and the second electrode being a positive electrode, and the other of the first electrode and the second electrode being a negative electrode; a plurality of bus bars, each bus bar connecting the first electrode of one battery and the second electrode of another battery, at least one of the bus bars being disposed obliquely; a flexible flat cable, the flexible flat cable including a plurality of wires disposed in parallel; and a plurality of connecting terminals, each connecting terminal including a first connecting portion and a second connecting portion, the first connecting portion being electrically connected to a corresponding bus bar, and the second connecting portion being electrically connected to a corresponding wire of the flexible flat cable.

In order to achieve the above object, the present disclosure adopts the following technical solution: a battery module, including: a plurality of batteries arranged in at least one group, each battery including a first electrode and a second electrode, one of the first electrode and the second electrode being a positive electrode, and the other of the first electrode and the second electrode being a negative electrode; a plurality of bus bars, each bus bar connecting the first electrode of one battery and the second electrode of another battery which is disposed adjacent to the one battery, each bus bar being disposed obliquely; a flexible flat cable, the flexible flat cable including a plurality of wires; and a plurality of connecting terminals, each connecting terminal including a first connecting portion electrically connected to a corresponding bus bar and a second connecting portion electrically connected to a corresponding wire of the flexible flat cable.

Compared with the prior art, at least one of the bus bars of the present disclosure is disposed obliquely, thereby reducing the difficulty of arranging the batteries. In addition, by electrically connecting the first connecting portion of the connecting terminal with the corresponding bus bar, and by electrically connecting the second connecting portion of the connecting terminal with the corresponding wire of the flexible flat cable, it is convenient to assemble the battery module.

### BRIEF DESCRIPTION OF DRAWINGS

FIG. 1 is a perspective schematic view of a battery module in accordance with an illustrated embodiment of the present disclosure;

FIG. 2 is a perspective schematic view of FIG. 1 from another angle;

FIG. 3 is a top view of FIG. 1, in which a plurality of batteries are schematically marked;

FIG. 4 is a partial enlarged view of a frame part A in FIG. 3;

FIG. 5 is a bottom view of FIG. 1;

FIG. 6 is a partial perspective exploded view of the battery module;

FIG. 7 is a partial enlarged view of a circled part B in FIG. 6;

FIG. 8 is a perspective schematic view of a connecting terminal in FIG. 7 in a first embodiment;

FIG. 9 is a perspective schematic view of FIG. 8 from another angle;

FIG. 10 is a top view of FIG. 9;

FIG. 11 is a bottom view of FIG. 9;

FIG. 12 is a side view of FIG. 9;

FIG. 13 is a front view of FIG. 9;

FIG. 14 is a perspective schematic view of a connecting terminal in a second embodiment;

FIG. 15 is a top view of FIG. 14;

FIG. 16 is a bottom view of FIG. 14;

FIG. 17 is a side view of FIG. 14; and

FIG. 18 is a front view of FIG. 14.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

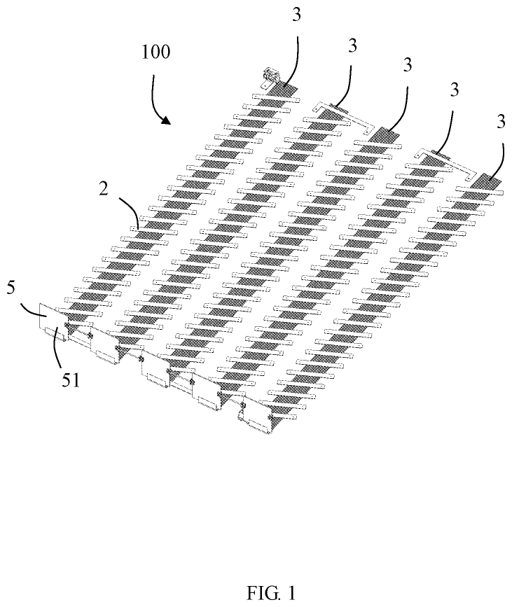

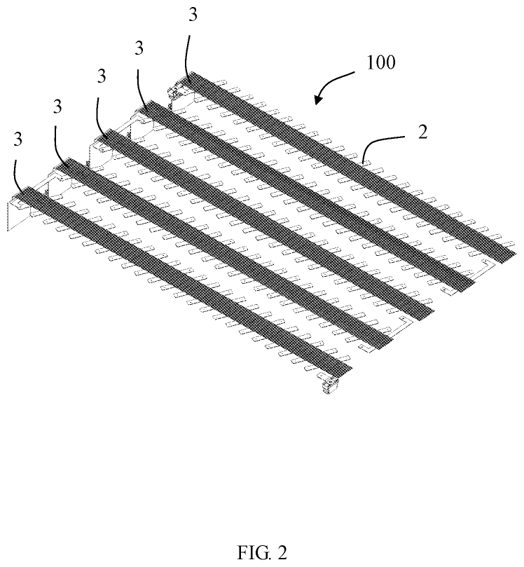

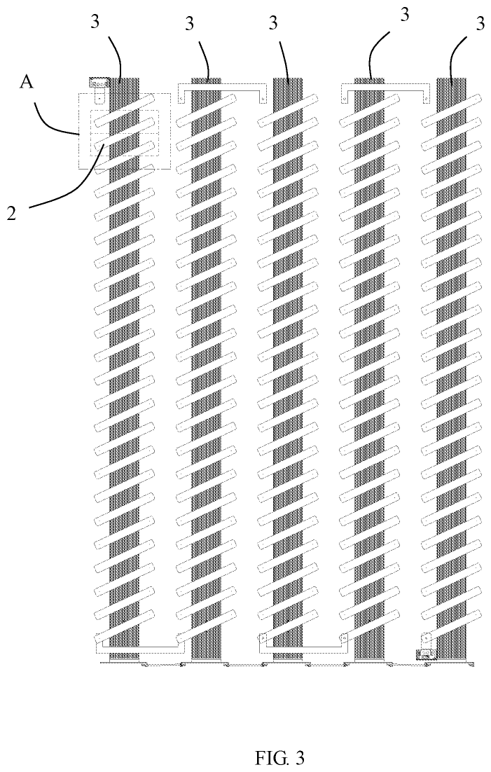

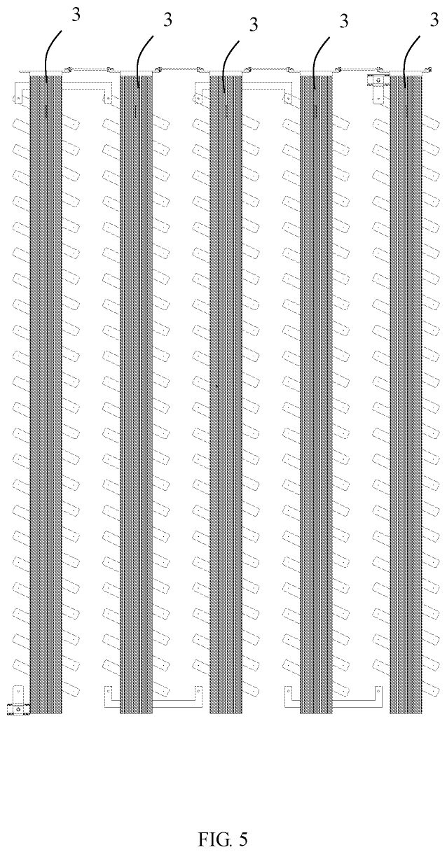

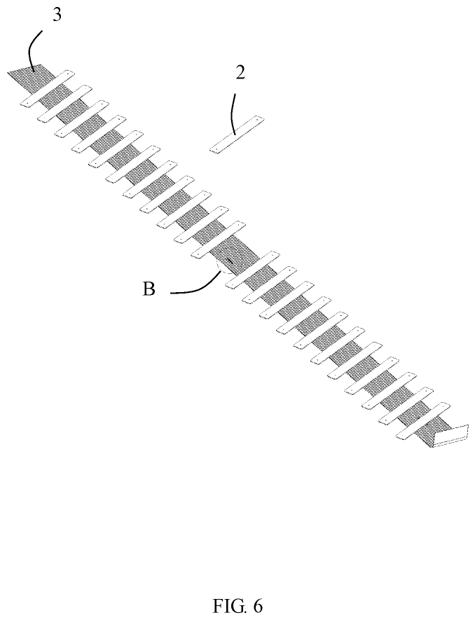

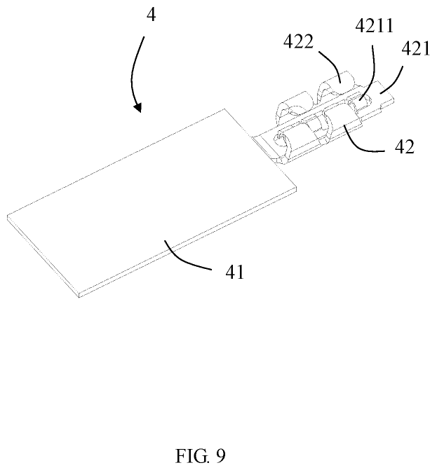

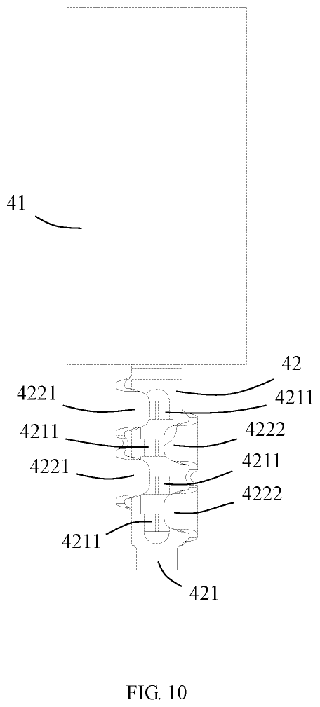

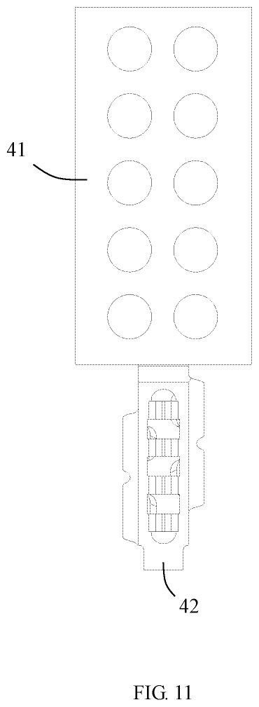

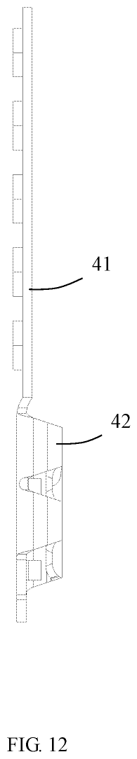

Referring to FIGS. 1 to 13, the present disclosure discloses a battery module 100 which is used as a power source for a device. The device includes, but is not limited to, a vehicle, a ship, or an aircraft etc. In an embodiment of the present disclosure, the battery module 100 is used in a vehicle. The vehicle is a pure electric vehicle, a hybrid vehicle or a range extended vehicle. The vehicle includes a vehicle body and a drive motor. The battery module 100 is disposed on the vehicle body (for example, a vehicle chassis). The battery module 100 is electrically connected to the drive motor. The battery module 100 provides electrical energy to the drive motor. The drive motor is connected to wheels on the vehicle body via a transmission mechanism in order to drive the vehicle to move.

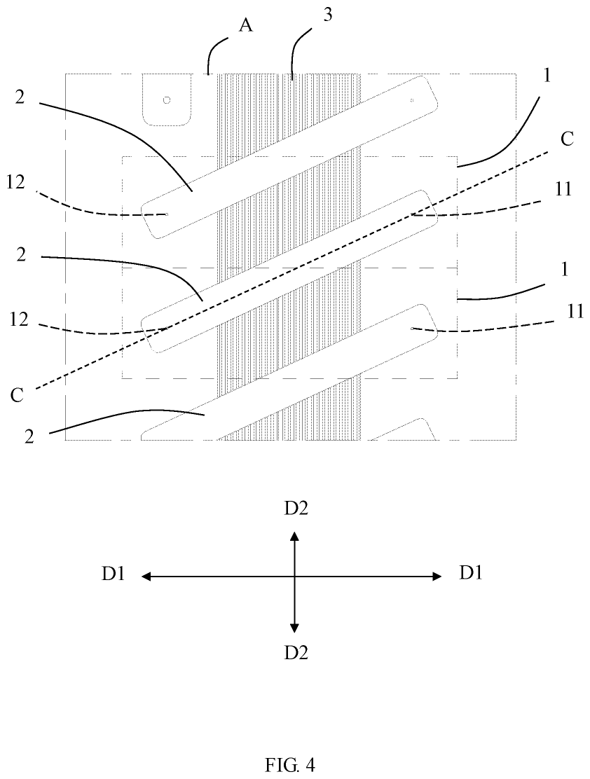

Referring to FIGS. 1 and 4, the battery module 100 includes a plurality of batteries 1, a plurality of bus bars 2 connecting the batteries 1 in series and/or in parallel, a plurality of flexible flat cables (FFCs for short) 3, a plurality of connecting terminals 4 connecting the bus bars 2 and a corresponding flexible flat cable 3, and a sampling component 5 electrically connected to the flexible flat cable 3. The sampling component 5 includes a sampling circuit board 51. The sampling circuit board 51 is connected to the batteries 1 through the flexible flat cable 3, the connecting terminals 4, and the bus bars 2 so as to collect voltage or temperature signals of the batteries 1, thereby realizing monitoring of the working status of the batteries 1 and improve the safety.

In the illustrated embodiment of the present disclosure, the batteries 1 are divided into multiple groups which are arranged in parallel. The multiple groups of batteries 1 are connected end to end to form a whole.

Each battery 1 includes a first electrode 11 and a second electrode 12, wherein one of the first electrode 11 and the second electrode 12 is a positive electrode, and the other of the first electrode 11 and the second electrode 12 is a negative electrode. In the illustrated embodiment of the present disclosure, the first electrode 11 and the second electrode 12 of each battery 1 are disposed along a first direction D1-D1. The plurality of batteries 1 in each group are disposed along a second direction D2-D2 perpendicular to the first direction D1-D1. The first electrode 11 of one battery 1 and the second electrode 12 of another battery 1, which is adjacent to the one battery 1, are disposed obliquely along a diagonal line C-C.

Each bus bar 2 connects the first electrode 11 of one battery 1 and the second electrode 12 of another battery 1 which is adjacent to the one battery 1. The bus bar 2 is disposed obliquely along the diagonal line C-C. The bus bar 2 has an included angle with the first direction D1-D1. The bus bar 2 also has an included angle with the second direction D2-D2. In an embodiment of the present disclosure, the bus bar 2 is made of a metal material (for example, nickel, aluminum, copper, etc.) to facilitate achieving better soldering and conductive effects.

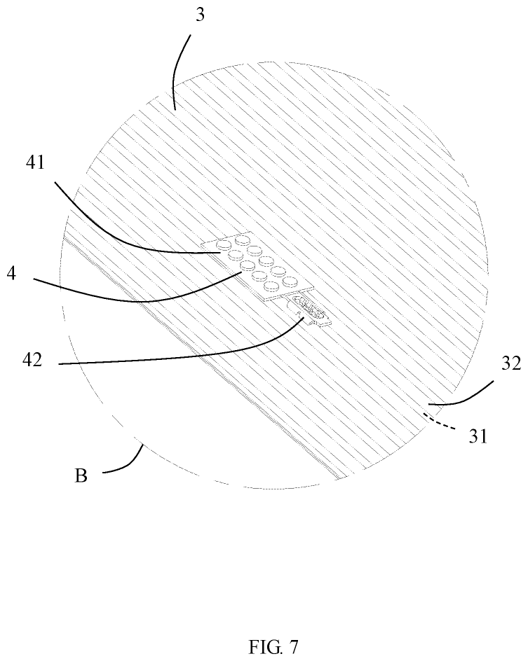

Referring to FIG. 7, the flexible flat cable 3 includes a plurality of wires 31 disposed in parallel and an insulating layer 32 which wraps the wires 31.

Referring to FIGS. 7 to 13, each connecting terminal 4 includes a first connecting portion 41 and a second connecting portion 42. The first connecting portion 41 is electrically connected to a corresponding bus bar 2. The second connecting portion 42 is electrically connected to a corresponding wire 31 of the flexible flat cable 3. In the illustrated embodiment of the present disclosure, the connecting terminal 4 is integrally formed.

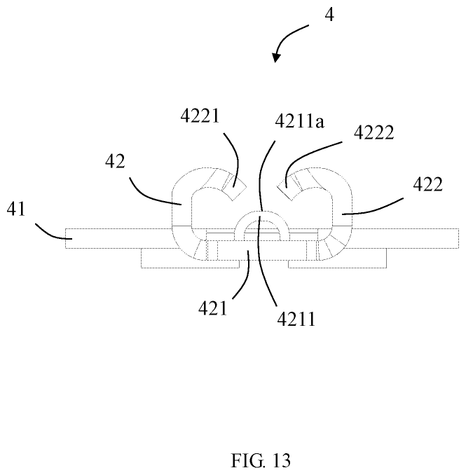

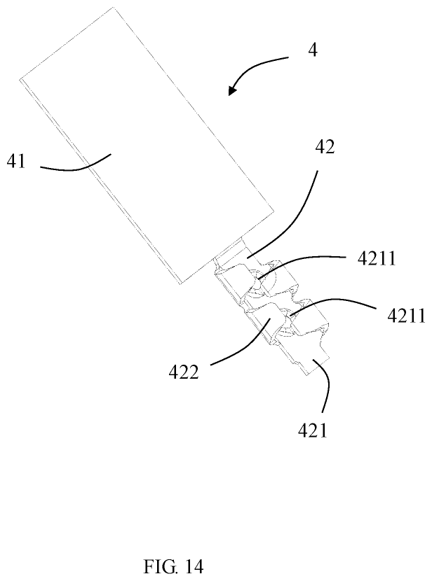

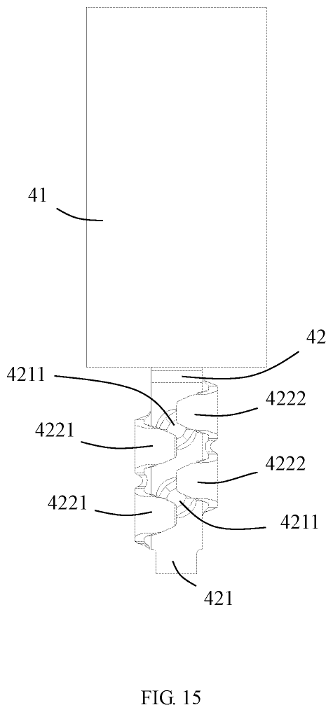

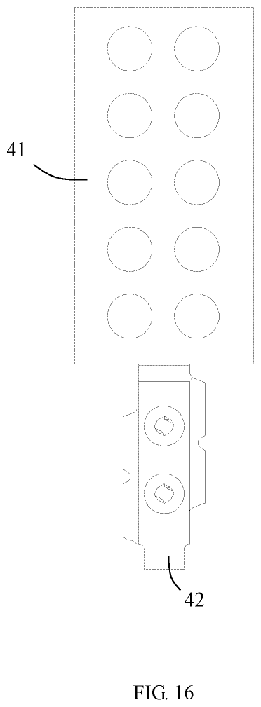

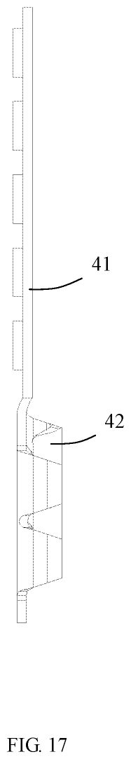

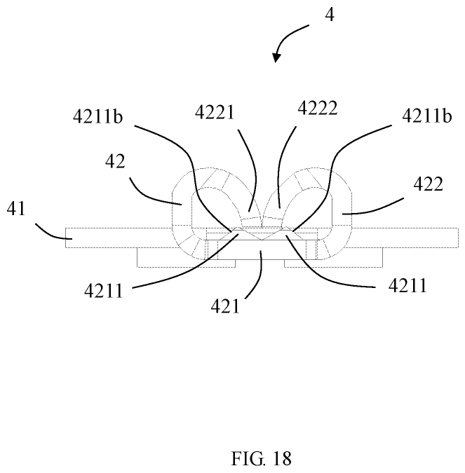

In the illustrated embodiment of the present disclosure, the first connecting portion 41 has a flat plate shape and is fixed to the bus bar 2 by soldering, for example, by spot soldering. The second connecting portion 42 includes a base portion 421 and a protrusion portion 422 extending from the base portion 421. The base portion 421 includes a raised portion 4211 protruding toward the flexible flat cable 3 and used to support the flexible flat cable 3. In the illustrated embodiment of the present disclosure, a plurality of the raised portions 4211 are provided and are stamped from the base portion 421. The raised portions 4211 are disposed at intervals along an extending direction of the base portion 421. Referring to FIG. 13, in a first embodiment of the present disclosure, each raised portion 4211 includes an arched supporting surface 4211a to support the flexible flat cable 3. In a second embodiment of the present disclosure, referring to FIGS. 14 to 18, each raised portion 4211 includes a tip 4211b to pierce the flexible flat cable 3.

The protrusion portion 422 is used to pierce the flexible flat cable 3 so that the second connecting portion 42 is electrically connected to the corresponding wire 31 of the flexible flat cable 3. The protrusion portion 422 is bent to be pressed and fixed on the corresponding wire 31 of the flexible flat cable 3. In the illustrated embodiment of the present disclosure, by providing the raised portion 4211, the raised portion 4211 can provide better support for the flexible flat cable 3. After the protrusion portion 422 is bent and pressed tightly, the protrusion portion 422 can achieve more reliable contact with the corresponding wire 31 of the flexible flat cable 3 and reduce the risk of poor contact. By providing the tip 4211b on the raised portion 4211, the tip 4211b can also pierce the flexible flat cable 3, thereby further improving the contact reliability between the second connecting portion 42 and the corresponding wire 31 of the flexible flat cable 3.

In the illustrated embodiment of the present disclosure, the protrusion portion 422 includes a plurality of first protrusion portions 4221 extending from one side of the base portion 421 and a plurality of second protrusion portions 4222 extending from the other side of the base portion 421. The plurality of first protrusion portions 4221 and the plurality of second protrusion portions 4222 are arranged in a staggered manner along a direction perpendicular to the extending direction of the base portion 421. Such an arrangement is beneficial for arranging a plurality of protrusion portions in a smaller space, thereby increasing the contact reliability between the protrusion portions and the corresponding wires 31 of the flexible flat cable 3. For example, when one or more of the protrusion portions are loose or broken, the remaining protrusion portions are in contact with the corresponding wires 31 of the flexible flat cable 3, so that the electrical connection between the connecting terminal 4 and the corresponding wire 31 of the flexible flat cable 3 can also be achieved. Preferably, a sum of the number of the first protrusion portions 4221 and the second protrusion portions 4222 is equal to the number of the raised portions 4211. With this arrangement, when the first protrusion portion 4221 and the second protrusion portion 4222 pierce the flexible flat cable 3 and are bent, each of the protrusion portions can be matched with the corresponding raised portion 4211 so as to improve the reliability of the protrusion portion 422 when pressing against the corresponding wire 31 of the flexible flat cable 3.

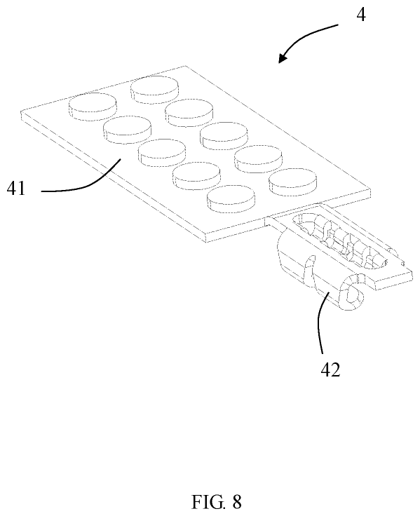

Referring to FIGS. 8 to 18, it is understandable to those skilled in the art that the protrusion portion 422 extends substantially in a direction (for example, a vertical direction) perpendicular to the extending direction of the base portion 421 before being bent. Before being bent, the protrusion portion 422 is substantially perpendicular to the flexible flat cable 3. As a result, it is advantageous for the protrusion portion 422 to pierce the insulating layer 32 of the flexible flat cable 3 so as to contact the corresponding wire 31 of the flexible flat cable 3.

It is understandable to those skilled in the art that, in the illustrated embodiment of the present disclosure, there are a plurality of bus bars 2 and a plurality of connecting terminals 4, respectively. The plurality of connecting terminals 4 have a same structure, that is, the connecting terminals 4 of a single specification are used, thereby saving cost.

In an embodiment of the present disclosure, when assembling, firstly, the connecting terminals 4 are assembled with the flexible flat cable 3 at a required position. The protrusion portion 422 pierces the insulating layer 32 of the flexible flat cable 3 and is in contact with the corresponding wire 31 of the flexible flat cable 3. Secondly, the connecting terminals 4 are designed with joint structures which can be soldered or welded to the bus bars 2. Finally, the bus bars 2 are assembled with the first electrodes 11 and the second electrodes 12 of the plurality of batteries 1 (for example, through soldering). Compared with the prior art, the difficulty and cost of the assembly process of the present disclosure can be greatly reduced.

The above embodiments are only used to illustrate the present disclosure and not to limit the technical solutions described in the present disclosure. The understanding of this specification should be based on those skilled in the art. Descriptions of directions, such as “front”, “back”, “left”, “right”, “top” and “bottom”, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. A battery module, comprising:
a plurality of batteries, each battery comprising a first electrode and a second electrode, one of the first electrode and the second electrode being a positive electrode, and the other of the first electrode and the second electrode being a negative electrode;
a plurality of bus bars, each bus bar connecting the first electrode of one battery and the second electrode of another battery, at least one of the bus bars being disposed obliquely;
a flexible flat cable, the flexible flat cable comprising a plurality of wires disposed in parallel; and
a plurality of connecting terminals, each connecting terminal comprising a first connecting portion and a second connecting portion, the first connecting portion being electrically connected to a corresponding bus bar, and the second connecting portion being electrically connected to a corresponding wire of the flexible flat cable.

2. The battery module according to claim 1, wherein the first electrode and the second electrode of each battery are disposed along a first direction, and the plurality of batteries are disposed along a second direction perpendicular to the first direction; and wherein the bus bar and the first direction and the bus bar and the second direction both have an included angle.

3. The battery module according to claim 1, wherein the first electrode of the one battery and the second electrode of the another battery are disposed obliquely along a diagonal line.

4. The battery module according to claim 1, wherein the first connecting portion is in a shape of a flat plate and is fixed to the corresponding bus bar by soldering.

5. The battery module according to claim 1, wherein the second connecting portion comprises a base portion and a protrusion portion extending from the base portion; and wherein the protrusion portion is adapted to pierce the flexible flat cable, so that the second connecting portion is electrically connected to the corresponding wire of the flexible flat cable.

6. The battery module according to claim 5, wherein the base portion comprises a raised portion protruding toward the flexible flat cable and adapted to support the flexible flat cable; and wherein the protrusion portion is bent to be fixed on the corresponding wire of the flexible flat cable.

7. The battery module according to claim 6, wherein the raised portion comprises an arched supporting surface to support the flexible flat cable.

8. The battery module according to claim 1, wherein the second connecting portion comprises a base portion, the base portion comprises a raised portion protruding toward the flexible flat cable, and the raised portion comprises a tip to pierce the flexible flat cable.

9. The battery module according to claim 6, wherein a plurality of the raised portions are provided on and stamped from the base portion, and the raised portions are disposed at intervals along an extending direction of the base portion.

10. The battery module according to claim 5, wherein the protrusion portion comprises a first protrusion portion extending from one side of the base portion and a second protrusion portion extending from the other side of the base portion; and wherein the first protrusion portion and the second protrusion portion are disposed in a staggered manner along a direction perpendicular to the extending direction of the base portion.

11. The battery module according to claim 1, wherein the plurality of connecting terminals have a same structure.

12. A battery module, comprising:
a plurality of batteries arranged in at least one group, each battery comprising a first electrode and a second electrode, one of the first electrode and the second electrode being a positive electrode, and the other of the first electrode and the second electrode being a negative electrode;
a plurality of bus bars, each bus bar connecting the first electrode of one battery and the second electrode of another battery which is disposed adjacent to the one battery, each bus bar being disposed obliquely;
a flexible flat cable, the flexible flat cable comprising a plurality of wires; and
a plurality of connecting terminals, each connecting terminal comprising a first connecting portion electrically connected to a corresponding bus bar and a second connecting portion electrically connected to a corresponding wire of the flexible flat cable.

13. The battery module according to claim 12, wherein the first electrode and the second electrode of each battery are disposed along a first direction, and the plurality of batteries are disposed along a second direction perpendicular to the first direction; and wherein the bus bar and the first direction and the bus bar and the second direction both have an included angle.

14. The battery module according to claim 12, wherein the first electrode of the one battery and the second electrode of the another battery are disposed obliquely along a diagonal line.

15. The battery module according to claim 12, wherein the first connecting portion is in a shape of a flat plate and is fixed to the corresponding bus bar by soldering.

16. The battery module according to claim 12, wherein the second connecting portion comprises a base portion and a protrusion portion extending from the base portion; and wherein the protrusion portion is adapted to pierce the flexible flat cable, so that the second connecting portion is electrically connected to the corresponding wire of the flexible flat cable.

17. The battery module according to claim 16, wherein the base portion comprises a raised portion protruding toward the flexible flat cable and adapted to support the flexible flat cable; and wherein the protrusion portion is bent to be fixed on the corresponding wire of the flexible flat cable.

18. The battery module according to claim 17, wherein the raised portion comprises an arched supporting surface to support the flexible flat cable.

19. The battery module according to claim 16, wherein the base portion comprises a plurality of raised portions provided on and stamped from the base portion, and the raised portions are disposed at intervals along an extending direction of the base portion, and each raised portion comprises a tip to pierce the flexible flat cable; and wherein the protrusion portion is bent to be fixed on the corresponding wire of the flexible flat cable.

20. The battery module according to claim 16, wherein the protrusion portion comprises a first protrusion portion extending from one side of the base portion and a second protrusion portion extending from the other side of the base portion; and wherein the first protrusion portion and the second protrusion portion are disposed in a staggered manner along a direction perpendicular to the extending direction of the base portion.
